(19) United States
(12) Patent Application Publication
(10) Pub. No.: US 2011/0169738 A1
(43) Pub. Date: Jul. 14, 2011

(54) OPTICAL NAVIGATION DEVICES

(75) Inventor: Mathieu REIGNEAU, Amilly (FR)

(73) Assignee: STMicroelectronics (Research & Development) Limited, Marlow-Buckinghamshire (GB)

(21) Appl. No.: 12/987,712

(22) Filed: Jan. 10, 2011

(30) Foreign Application Priority Data
Jan. 11, 2010 (GB) 1000347.3

(51) Int. Cl. G06F 3/033

(52) U.S. Cl. 345/166

(57) ABSTRACT

An imaging device may have illumination paths directed to an imaging area to thereby illuminate the whole of the imaging surface. The imaging area may be adapted to generate frustrated total internal reflection of the illumination from the imaging surface, in the presence of an element in contact with some or all of the imaging surface.

### FIELD OF THE INVENTION

The present invention relates to optical navigation devices and, more specifically, to an optical mouse navigation device.

### BACKGROUND OF THE INVENTION

Computer devices are becoming ever smaller, and full computing functionality can be found on phones and smart phones and other personal digital assistants (PDA). As the computer devices become smaller, the various features of the computer devices may also become smaller. This may include a requirement for smaller input systems for the user to enter input data into the device. One such input system is an optical navigation device. Many computer devices, large and small, are equipped with optical navigation devices. However, with the smaller computer devices, minimizing the size of the optical navigation device can often be restrictive and problematic.

A number of devices may offer thin optical navigation devices. These have had some success, but the design may generally not allow for full illumination of the whole sensor as a result of the small size of the device. This in turn may tend to make the optical navigation devices inefficient and on occasions incapable of operating. The inability to illuminate the full sensor may be particularly relevant in the case of sensors that are less than 5 mm thick. This is due to the fact that very expensive optics may be used in order to diverge a light beam sufficiently within the small width to illuminate the sensor. Even with the use of expensive optics, the required divergence may still not be achievable.

FIG. 1 shows an example of this problem when a light emitting diode (LED) 100 is used to illuminate an imaging area 102 by way of an input lens 104 and a mirror 106. Due to the thickness T of the imaging device, it may not be possible to illuminate the whole of the imaging area 102 irrespective of the curvature of the mirror 106. As a result, any illumination that is totally internally reflected from the imaging area by way of total internal frustrated reflection may occur only in the areas where the illumination has illuminated the imaging area 102. This may make the imaging area and the resultant sensed radiation non-optimal. Making a thicker sensor may overcome some of this problem, but it is the reduction in size which is also sought in this domain which may prevent this approach from being useful.

### SUMMARY OF THE INVENTION

It is an object to provide an optical navigation device having a thin sensor which has a greater overall illumination than previous devices.

According to an aspect, an imaging device may have a plurality of illumination paths directed to an imaging area to thereby illuminate the whole of the imaging surface. The imaging area may be adapted to generate frustrated total internal reflection of the illumination from the imaging surface, in the presence of an element in contact with some or all of the imaging surface.

The imaging device may offer a number of benefits. These may include a thin sensor having a thickness of less than 5 mm, which can be formed from a single optical element. The optical element may be able to fully illuminate an imaging area with cheap and simple optics despite the thinness of the imaging device. Other advantages may be apparent from the description.

### BRIEF DESCRIPTION OF THE DRAWINGS

Reference may now be made, by way of example, to the accompanying drawings, in which:

FIG. 1 is a cross-sectional diagram of an imaging device for an optical navigation device, according to the prior art;

FIG. 2 is an optical navigation device, according to the present invention;

FIG. 3 is a cross-sectional diagram of an imaging device for an optical navigation device, according to the present invention; and

FIG. 4 is a cross-sectional diagram of an imaging device for an optical navigation device, according to the present invention.

### DETAILED DESCRIPTION OF THE PREFERRED EMBODIMENTS

The present invention relates to an imaging device associated with an optical navigation device. The optical navigation device is a mouse of small-scale which is intended to be operated by way of frustrated total internal reflection (F-TIR) in order to recognize the movement of a finger on an imaging area. This type of mouse is herein referred to as a finger mouse.

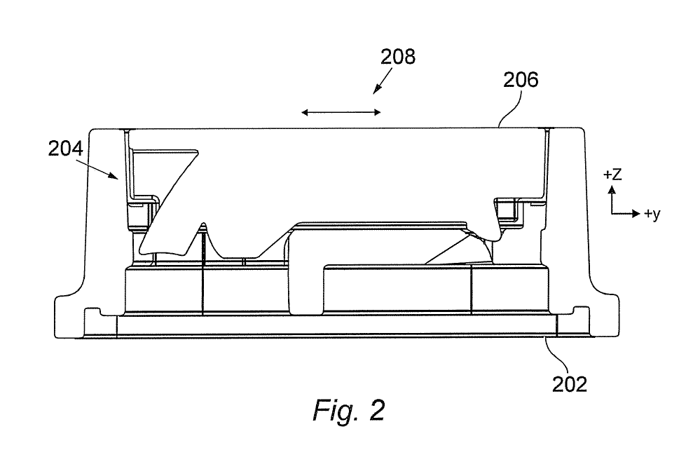

FIG. 2 shows an example of a finger mouse 200 in accordance with an embodiment of the present disclosure. The finger mouse includes a base 202; an imaging device shown generally at 204; and an LED and sensor, both not shown per se. The top surface 206 of the imaging device 204 includes an imaging area 208 which is positioned at a predetermined location on the surface 206. It may be appreciated that the position of the imaging area may depend on the optical path or paths that light takes from the LED to the sensor. This may be described in greater detail below.

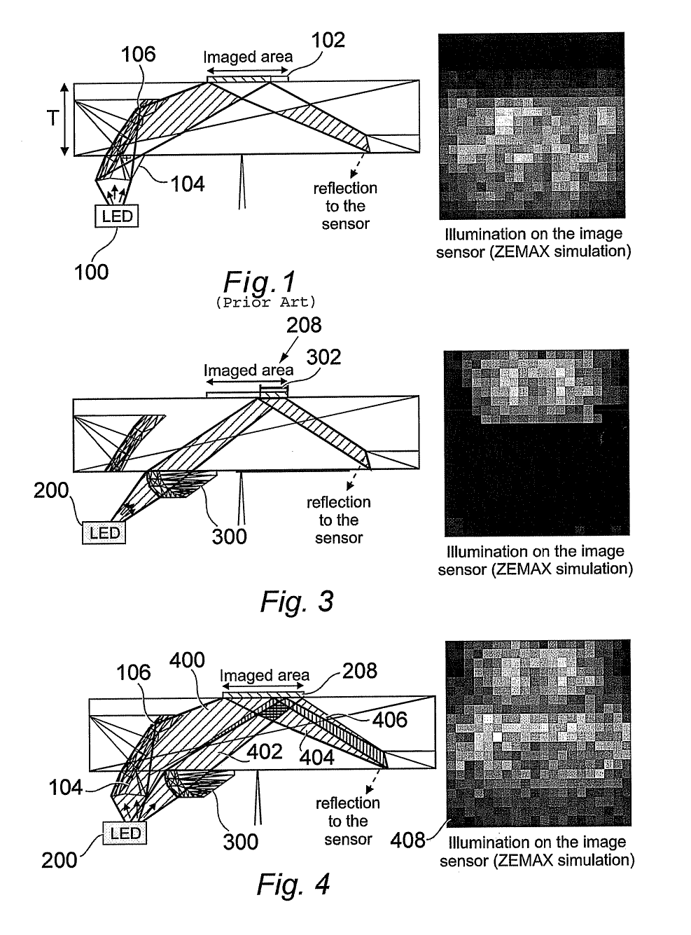

Referring to FIG. 3, instead of adjusting the optics of lens element 104 and mirror 106 in FIG. 1, which may either add thickness to the imaging device or cost, due to more costly optics; the present disclosure takes a different approach. The present disclosure provides an additional lens element 300 which directs light from the LED to the imaging area 208 thereby illuminating an area 302. The area 302 reflects the light to the sensor (not shown). By adding additional lens element 300, the overall illumination of the imaging area 208 is achieved as is shown with reference to FIG. 4.

In FIG. 4, light from the LED 200 is directed in two beams 400 and 402 by way of lens 104 and mirror 106 and additional lens element 300 respectively, to the imaging area 208. The illumination from a plurality of different illumination paths, in this case a dual illumination path, covers the whole of the imaging area. Frustrated total internal reflection then causes the dual illumination paths to be reflected (404, 406) from the imaging surface 208 to the sensor (not shown). The illumination on the image sensor is seen in the simulation picture 408. The description relates to a dual illumination, but it may be appreciated that other pluralities of paths may work equally well and indeed may even facilitate a still smaller thickness for the imaging device.

In use in an optical navigation system, this imaging device may enable total illumination of the imaging area 208, thereby improving the operation of the imaging device when used as a finger mouse. Movement of a finger anywhere on the imaging area 208 may be sensed by the above described device, whereas in the prior art, movement would only be sensed in those areas where the imaging area is illuminated. The present disclosure may thus provide a larger active area for user input and ensure that no user input is missed due to the fact that some of the imaging area is not illuminated. In addition, the device of the present disclosure may retain a thin and a compact design with simple optical elements that are cost-effective. The thickness of the imaging device may generally be less than 5 mm and desirably 3 mm or less.

The imaging device can be formed from a single piece molding as shown in FIG. 2. The molding includes each of the individual optical elements shown in FIG. 4, namely lens element 104 and mirror 106; additional lens element 300; imaging area 208; and the optics used to transfer the reflected dual path illumination to the sensor. The imaging device could alternatively be made in other appropriate ways with different optical elements which produce the same optical effect. The imaging device may also be made from a number of different elements, rather than a single molding. The technique for forming the imaging device may include other techniques than molding, such as pasting optical elements with a matching index glue replication techniques, stamping, embossing or machining. The optical device is typically made from plastic based material such as PMMA Polycarbonate (such as Lexan), glass, Polyethylene or PVB.

The sensor is of any appropriate type and may be a CMOS sensor having an array of pixels for measuring reflected light at different locations of the imaging area 208 to produce an image as simulated at 400.

The LED may be of any appropriate type and may generate a source in the “optical” or non-optical ranges. Accordingly, reference to optics and optical are intended to cover wavelengths which are not in the human visible range. The imaging device is intended for use in an optical navigation device; however it may be appreciated that the imaging device could be used in any appropriate device, for example, an optical pushbutton, a fingerprint scanner, lab-on-chip devices, or bio-optical sensors (e.g. for detecting chemi-fluorescent for medical or biotesting applications). The optical navigation device may be used in any suitable devices, such as a mobile or smart phone, other personal or communications devices, a computer, a camera, a remote controller, access device or any other suitable device.

1-17. (canceled)

18. An imaging device comprising:
an imaging surface;
first and second optical lens elements; and
at least one light source configured to cooperate with said first and second optical lens elements to generate a plurality of illumination paths directed to said imaging surface;
said imaging surface configured to generate frustrated total internal reflection of the plurality of illumination paths with an element to be in contact with at least a part of said imaging surface.

19. The imaging device of claim 18 wherein said at least one light source is configured to illuminate all of said imaging surface.

20. The imaging device of claim 18 wherein said imaging surface, said first and second optical lens elements, and said at least one light source have a total thickness less than 5 mm.

21. The imaging device of claim 18 wherein said imaging surface, said first and second optical lens elements, and said at least one light source have a total thickness less than 3 mm.

22. The imaging device of claim 18 wherein said at least one light source is configured to generate two illumination paths respectively through said first and second optical lens elements.

23. The imaging device of claim 18 wherein said at least one light source comprises a single light source.

24. The imaging device of claim 18 further comprising a sensor configured to receive the plurality of illumination paths from said imaging surface.

25. The imaging device of claim 18 wherein said first and second optical lens elements are different from one another.

26. The imaging device of claim 18 wherein said imaging surface, and said first and second optical lens elements are formed from a single formed element.

27. An imaging device comprising:
an imaging surface;
first and second optical lens elements configured to direct a plurality of illumination paths to said imaging surface;
said imaging surface configured to generate frustrated total internal reflection of the plurality of illumination paths with an element to be in contact with at least a part of said imaging surface.

28. The imaging device of claim 27 wherein said first and second optical lens elements are configured to illuminate all of said imaging surface.

29. The imaging device of claim 27 wherein said first and second optical lens elements are configured to generate two illumination paths respectively therethrough.

30. The imaging device of claim 27 further comprising a sensor configured to receive the plurality of illumination paths from said imaging surface.

31. An optical navigation device comprising:
an imaging surface configured to receive a finger of a user;
first and second optical lens elements;
at least one light source configured to cooperate with said first and second optical lens elements to generate a plurality of illumination paths directed to said imaging surface;
said imaging surface configured to generate frustrated total internal reflection of the plurality of illumination paths with the finger to be in contact with at least a part of said imaging surface; and
a sensor configured to receive the plurality of illumination paths from said imaging surface to detect movement of the finger.

32. The optical navigation device of claim 31 wherein said at least one light source is configured to illuminate all of said imaging surface.

33. The optical navigation device of claim 31 wherein said at least one light source is configured to generate two illumination paths through said first and second optical lens elements.

34. The optical navigation device of claim 31 wherein said at least one light source comprises a single light.

35. An electronic device comprising:
an imaging device comprising
an imaging surface,
first and second optical lens elements, and
at least one light source configured to cooperate with said first and second optical lens elements to generate a plurality of illumination paths directed to said imaging surface,
said imaging surface configured to generate frustrated total internal reflection of the plurality of illumination paths with an element to be in contact with at least a part of the imaging surface.

36. The electronic device of claim 35 wherein said at least one light source is configured to illuminate all of said imaging surface.

37. The electronic device of claim 35 wherein said imaging device comprises an optical navigation device.

38. The electronic device of claim 37 wherein the optical navigation device comprises a mouse.

39. The electronic device of claim 38 wherein said mouse comprises a finger mouse.

40. The electronic device of claim 35 wherein said imaging device comprises a computer.

41. The electronic device of claim 35 wherein said imaging device comprises a phone.

42. The electronic device of claim 35 wherein said imaging device comprises a camera.

43. A method of making an imaging device comprising:
providing an imaging surface; and
coupling first and second optical lens elements to direct a plurality of illumination paths to the imaging surface, the imaging surface generating frustrated total internal reflection of the plurality of illumination paths with an element to be in contact with at least a part of the imaging surface.

44. The method of claim 43 wherein the coupling comprises coupling the first and second optical lens elements to illuminate all of the imaging surface.

45. The method of claim 43 wherein the coupling comprises coupling the first and second optical lens elements to generate two illumination paths respectively therethrough.

46. The method of claim 43 further comprising coupling a sensor to receive the plurality of illumination paths from the imaging surface.

47. The method of claim 43 further comprising integrally molding the first and second optical lens elements and the imaging surface.
